(19) United States
(12) Patent Application Publication
(10) Pub. No.: US 2023/0102423 A1
(43) Pub. Date: Mar. 30, 2023

(54) Efficient Three-Party Private Set Intersection (PSI)

(71) Applicant: VMware, Inc., Palo Alto, CA (US)

(72) Inventor: Avishay Yanai, Herzliya (IL)

(21) Appl. No.: 17/487,547

(22) Filed: Sep. 28, 2021

(51) Int. Cl. H04L 9/08; H04L 9/14

(52) U.S. Cl. CPC H04L 9/0869; H04L 9/14

(57) ABSTRACT

Techniques for implementing efficient three-party private set intersection (PSI) are provided. In one set of embodiments these techniques make use of an oblivious key-value store (OKVS), which is a cryptographic data structure that encodes a set of key-value pairs ({kᵢ, vᵢ}) and exhibits the following properties: (A) if a receiver decodes the OKVS on some input q=kⱼ, the output will be vⱼ, and (B) the receiver cannot tell, from the outputs generated by the OKVS, what keys (i.e., kᵢ's) are encoded. By using an OKVS, the techniques of the present disclosure can achieve three-party PSI in a manner that is more efficient and scalable than existing protocols.

### BACKGROUND

Private set intersection (PSI) is a cryptographic technique that allows multiple parties, each holding a set of items private to that party, to learn the intersection of the sets—or in other words, the items that appear in all of the sets—and no other information. PSI has many privacy-preserving applications, such as enabling users with private calendars to find a commonly available time slot for a meeting; companies with private customer databases to find a target audience for a cross-company advertising campaign; and enterprises with private audit logs of connections to their corporate networks to identify similar (e.g., potentially malicious) activities in all networks. Recently, PSI has been used to implement private contact tracing applications for COVID-19, thereby allowing diagnosed users and healthcare providers to privately match contact information and notify other users who may have been infected.

There are several known protocols for efficiently implementing PSI in the context of exactly two parties (i.e., two-party PSI). However, current protocols for implementing PSI in the context of three or more parties are significantly less performant and scalable.

### BRIEF DESCRIPTION OF THE DRAWINGS

FIG. 1 depicts an example environment according to certain embodiments.

FIG. 2 depicts the high-level design of a three-party PSI protocol according to certain embodiments.

FIG. 3 depicts a protocol workflow according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to an efficient and secure protocol for implementing private set intersection in the context of three parties (i.e., three-party PSI). Unlike existing three-party PSI protocols, the protocol of the present disclosure makes use of an oblivious key-value store (OKVS), which is a cryptographic data structure that encodes a set of key-value pairs ({kᵢ, vᵢ}) having (pseudo)random vᵢ values. When an OKVS is provided to a receiver, the receiver can evaluate (i.e., decode) the OKVS to generate an output for any input q.

The characteristics of the OKVS ensure that (A) if the receiver decodes the OKVS on some input q=kⱼ, the output will be vⱼ, and (B) the receiver cannot tell, from the outputs generated by the OKVS, what keys (i.e., kᵢ's) are encoded.

By leveraging an OKVS, the protocol of the present disclosure can achieve three-party PSI in a manner that is more efficient and scalable than existing techniques. The foregoing and other aspects are described in further detail in the sections that follow.

### 2. Example Environment and High-Level Protocol Design

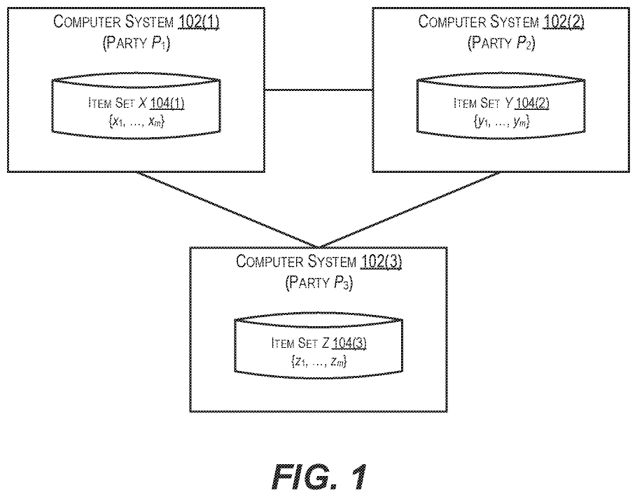

FIG. 1 depicts an example environment 100 in which embodiments of the present disclosure may be implemented. As shown, environment 100 includes three computer systems 102(1), 102(2), and 102(3) that are operated by three parties (e.g., organizations, individuals, etc.) P₁, P₂, and P₃ respectively. Each party maintains on its computer system a set of items 104 that is private to (i.e., only known by) that party. In particular, party P₁ maintains an item set X (reference numeral 104(1)) comprising items {x₁, . . . , xₘ}, party P₂ maintains an item set Y (reference numeral 104(2)) comprising items {y₁, . . . , yₘ}, and party P₃ maintains an item set Z (reference numeral 104(3)) comprising items {z₁, . . . , zₘ}. These items may include any type of data instance that is of interest to the parties, such as user identifiers (IDs), device serial numbers, data checksums, etc.

It is assumed that parties P₁, P₂, and P₃ wish to execute three-party PSI with respect to their item sets X, Y, and Z and thus learn the intersection of these three sets, without revealing any other information to each other. For example, if P₁, P₂, and P₃ are different companies and item sets X, Y, and Z are customer datasets maintained by the companies, P₁, P₂, and P₃ may wish to identify the customers that they have in common for cross-marketing purposes, without letting each other know the customers that are unique to each company.

However, as noted the Background section, existing protocols for implementing three-party PSI generally suffer from poor performance and scalability. This is largely due to the fact that these existing protocols employ a particular type of cryptographic primitive, known as an oblivious programmable pseudorandom function (OPPRF), which requires, among other things, (1) multiple rounds of communication between every pair of parties {P₁, P₂}, {P₁, P₃}, and {P₂, P₃}, and (2) the use of asymmetric (i.e., public-private) key operations. The combination of (1) and (2) results in a degree of communication and resource overhead that can quickly render these existing protocols impractical as the number of items in each party's item set is scaled upward.

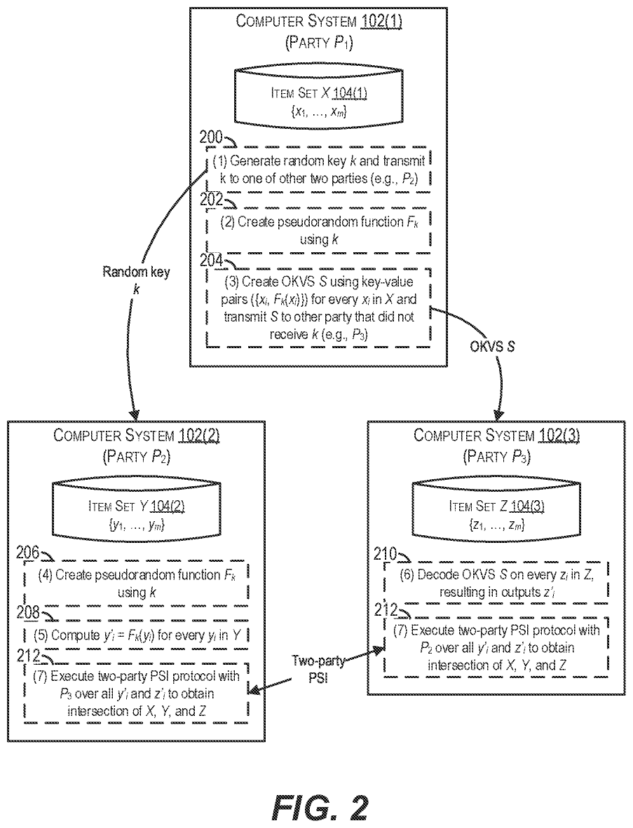

To address the foregoing and other similar problems, FIG. 2 depicts the high-level design of an efficient three-party PSI protocol that may be implemented by parties P₁, P₂, and P₃ of FIG. 1 according certain embodiments. This protocol leverages two types of cryptographic primitives (both of which are distinct and different from OPPRF): a pseudorandom function, which is a deterministic function that is created via a key and, for every possible input, generates an output that is indistinguishable from the output of a truly random function; and an oblivious key-value store (OKVS), which is a key-value data structure that supports decode and encode operations. The decode operation causes the OKVS to output a value in response to a query q.

The encode operation takes as input a set of key-value pairs ({kᵢ, vᵢ}) for i=1, . . . , n comprising (pseudo)random values {v₁, . . . , vₙ} and generates an OKVS that (A) outputs vⱼ when decoded on a query q=kⱼ and (B) outputs a random value when decoded on a query q ∉{k₁, . . . , kₙ}. Property (B) ensures that the receiver of the OKVS (i.e., the party performing decode operations) cannot tell what kᵢ's are encoded.

Starting with step (1) of the protocol (reference numeral 200), a first party (e.g., P₁) can generate a random key k and transmit k to one of the other two parties (e.g., P₂).

At step (2) (reference numeral 202), Party P₁ can create a pseudorandom function Fₖ using random key k. Party P₁ can further create an OKVS S by invoking the encode operation using the key-value pairs ({xᵢ, Fₖ(xᵢ)}) for every xᵢ in its item set X and can transmit S to the other party that did not receive random key k (i.e., P₃) (step (3); reference numeral 204). Note that due to the two OKVS properties mentioned above, OKVS S will output Fₖ(xⱼ) when decoded on a query q=xⱼ and output a random value when decoded on a query q ∉ X.

At steps (4) and (5) (reference numerals 206 and 208), party P₂ can create the same pseudorandom function Fₖ created by party P₁ at step (2) using random key k and can compute y′ᵢ=Fₖ(yᵢ) for every yᵢ in its item set Y. In addition, at step (6) (reference numeral 210), party P₃ can invoke the decode operation of OKVS S on every zᵢ in its item set Z, resulting in outputs z′ᵢ.

Finally, at step (7) (reference numeral 212), parties P₂ and P₃ can execute a two-party PSI protocol over inputs {y′ᵢ}_{i∈[m]} and {z′ᵢ}_{i∈[m]}, thereby allowing the parties to obtain the intersection of item sets X, Y, and Z (i.e., X ∩ Y ∩ Z). Note that at the end of step (6), if an item a is in the intersection, both P₂ and P₃ will have y′ⱼ=z′ⱼ, =Fₖ(a) for some j and j′. For party P₂, this follows directly from the computation performed at step (5). For party P₃, this follows from property (A) of OKVS S mentioned earlier, which ensures that S outputs Fₖ(xⱼ) when decoded on a query q=xⱼ (and thus will output Fₖ(a) on an item a that exists in both item set X of P₁ and item set Z of P₃). On the other hand, if item a is not in the intersection, then either P₂ or P₃ (or both) will not have Fₖ(a). Thus, the execution of the two-party PSI protocol at step (7) finds exactly those items that are in the item sets of all three parties.

With the protocol shown in FIG. 2, a number of advantages are realized over existing three-party PSI protocols. First, because OKVS S is communicated via a single message between only two parties (i.e., P₁ and P₃) and because P₃ can decode S on each of the items in its item set Z without any further message exchanges with P₁, the communication and resource overhead of this protocol is significantly lower, resulting in improved performance and scalability.

Second, this protocol can be flexibly modified to make use of any two-party PSI protocol known in the art at step (7). In certain embodiments, a server-aided two-party PSI protocol can be employed, which is generally faster than conventional two-party PSI. In these embodiments, the protocol of the present disclosure can rely solely on symmetric key primitives and thus can completely avoid public key operations. A particular implementation of this approach is detailed in section (3) below.

It should be appreciated that FIGS. 1 and 2 are illustrative and not intended to limit embodiments of the present disclosure. For example, although these figures indicate that item sets X, Y, and Z of parties P₁, P₂, and P₃ each include the same number of items (i.e., m), this is not necessary; each item set can include a different number of items. Further, although FIGS. 1 and 2 depict a particular arrangement of entities within environment 100, other arrangements are possible (e.g., the functionality attributed to a particular entity may be split into multiple entities, entities may be combined, etc.). One of ordinary skill in the art will recognize other variations, modifications, and alternatives.

### 3. Protocol Workflow

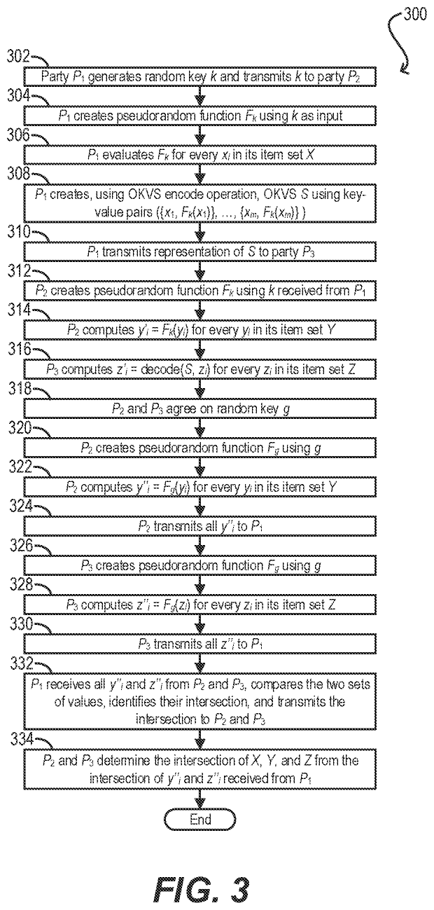

FIG. 3 depicts a workflow 300 that provides additional details regarding the processing that may be performed by parties P₁, P₂, and P₃ as part of the three-party PSI protocol shown in FIG. 2 according to certain embodiments. Workflow 300 assumes that parties P₂ and P₃ use a server-aided two-party PSI protocol in order to obtain the intersection of their y′ₜ and z′ₜ values per step (7) of FIG. 2, with party P₁ acting as the two-party protocol server.

Starting with block 302, party P₁ can generate a random key k and transmit k to party P₂. This random key may be a number of length s bits, such as 128 or 256 bits.

At block 304, party P₁ can create a pseudorandom function Fₖ using random key k as input. In various embodiments, pseudorandom function Fₖ can be computed in polynomial time with respect to key length s and cannot be distinguished from a truly random function in polynomial time.

Party P₁ can then evaluate Fₖ(xᵢ) for every xᵢ ∈ X (block 306) and can create, using an OVKS encode operation, an OKVS S using key-value pairs ({x₁, Fₖ(x₁)}, . . . , {xₘ, Fₖ(xₘ)}) (block 308). As noted previously, the creation of OKVS S in this manner will cause S to output Fₖ (xⱼ) when decoded on a query q=xⱼ and output a random value when decoded on a query q ∉ X. Upon creating OKVS S, party P₁ can transmit a representation of S to party P₃ (block 310). The specific nature of this representation can vary depending on the implementation of the encode operation. For example, in a particular embodiment, OKVS S may be represented as an (m−1) degree polynomial p where p is interpolated over points ({x₁, Fₖ(x₁)}, . . . , {xₘ, Fₖ(xₘ)}). In other embodiments OKVS S may be represented using a more complex data structure, such as a PaXoS data structure.

At blocks 312 and 314, party P₂ can generate pseudorandom function Fₖ using random key k received from party P₁ and can compute y′ᵢ=Fₖ(yᵢ) for every yᵢ in its item set Y (i.e., for i=1, . . . , m). In addition, at block 316, party P₂ can compute z′ᵢ=decode(S, zᵢ) for every zᵢ in its item set Z (i.e., for i=1, . . . , m).

Parties P₂ and P₃ can thereafter carry out a server-aided two-party PSI protocol with respect to their computed values {y′ᵢ}_{i∈[m]} and {z′ᵢ}_{i∈[m]}, with party P₁ acting as the server. For example, at block 318, parties P₂ and P₃ can agree on a random key g that is different from previously discussed random key k.

Upon agreeing upon random key g, party P₂ can create a new pseudorandom function F_{g} using g (block 320), compute y″ᵢ=F_{g} (y′ᵢ) for every yᵢ in its item set Y (i.e., for i=1, . . . , m) (block 322), and transmit {y″ᵢ}_{i∉[m]} to party P₁ (block 324). Similarly, party P₃ can generate pseudorandom function F_{g} using g (block 326), compute z″ᵢ=F_{g}(z′ᵢ) for every zᵢ in its item set Z (i.e., for i=1, . . . , m) (block 328), and transmit {z″ᵢ}_{i∈[m]} to party P₁ (block 330).

At block 332, party P₁ can receive all of the y″ᵢ and z″ᵢ values from parties P₂ and P₃ respectively. Note that because party P₁ does not know random key g, all of these values look like random values to P₁. Party P₁ can then compare the set of y″ᵢ's to the set of z″ᵢ's, identify the intersection of these two sets, and send the intersection back to parties P₂ and P₃.

Finally, parties P₂ and P₃ can determine, from the intersection of {y″ᵢ}_{i∉[m]} and {z″ᵢ}_{i∉[m]} received from party P₁, the intersection of sets X, Y, and Z (block 334) and workflow 300 can end.

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations and equivalents can be employed without departing from the scope hereof as defined by the claims.

What is claimed is:

1. A method for implementing efficient three-party private set intersection (PSI), the method comprising:
generating, by a first computer system operated by a first party, a random key k;
transmitting, by the first computer system, the random key k to a second computer system operated by a second party;
creating, by the first computer system, a pseudorandom function Fₖ using the random key k;
creating, by the first computer system, an oblivious key-value store (OKVS) using a set of key-value pairs ({xᵢ, Fₖ(xᵢ)}) for each item xᵢ in an item set X that is private to the first party; and
transmitting, by the first computer system, the OKVS to a third computer system operated by a third party.

2. The method of claim 1 wherein upon receiving the random key k, the second computer system:
creates the pseudorandom function Fₖ using the random key k; and
computes y′ᵢ=Fₖ(yᵢ) for each item yᵢ in an item set Y that is private to the second party.

3. The method of claim 2 wherein upon receiving the OKVS, the third computer system:
decodes the OKVS using each item zᵢ in an item set Z that is private to the third party, resulting in a set of values z′ⱼ.

4. The method of claim 3 wherein the second and third computer systems execute a two-party PSI protocol using y′ᵢ and z′ᵢ as inputs in order to determine an intersection of the item sets X, Y, and Z.

5. The method of claim 4 wherein the two-party PSI protocol executed by the second and third computer systems is a server-aided two-party PSI protocol.

6. The method of claim 5 wherein the first computer system acts as a server in the server-aided two-party PSI protocol.

7. The method of claim 1 wherein the OKVS is configured to:
output Fₖ(xⱼ) when decoded on an input xⱼ in the item set X; and
output a random value when decoded on an input that is not in the item set X.

8. A non-transitory computer readable storage medium having stored thereon program code executable by a first computer system operated by a first party, the program code embodying a method for implementing efficient three-party private set intersection (PSI), the method comprising:
generating a random key k;
transmitting the random key k to a second computer system operated by a second party;
creating a pseudorandom function Fₖ using the random key k;
creating an oblivious key-value store (OKVS) using a set of key-value pairs ({xᵢ, Fₖ(xᵢ)}) for each item xᵢ in an item set X that is private to the first party; and
transmitting the OKVS to a third computer system operated by a third party.

9. The non-transitory computer readable storage medium of claim 8 wherein upon receiving the random key k, the second computer system:
creates the pseudorandom function Fₖ using the random key k; and
computes y′ᵢ=Fₖ(yᵢ) for each item yᵢ in an item set Y that is private to the second party.

10. The non-transitory computer readable storage medium of claim 9 wherein upon receiving the OKVS, the third computer system:
decodes the OKVS using each item zᵢ in an item set Z that is private to the third party, resulting in a set of values z′ᵢ.

11. The non-transitory computer readable storage medium of claim 10 wherein the second and third computer systems execute a two-party PSI protocol using y′ᵢ and z′ᵢ as inputs in order to determine an intersection of the item sets X, Y, and Z.

12. The non-transitory computer readable storage medium of claim 11 wherein the two-party PSI protocol executed by the second and third computer systems is a server-aided two-party PSI protocol.

13. The non-transitory computer readable storage medium of claim 12 wherein the first computer system acts as a server in the server-aided two-party PSI protocol.

14. The non-transitory computer readable storage medium of claim 8 wherein the OKVS is configured to:
output Fₖ (xⱼ) when decoded on an input xⱼ in the item set X; and
output a random value when decoded on an input that is not in the item set X.

15. A first computer system operated by a first party, the first computer system comprising:
a processor; and
a non-transitory computer readable medium having stored thereon program code that, when executed, causes the processor to:
generate a random key k;
transmit the random key k to a second computer system operated by a second party;
create a pseudorandom function Fₖ using the random key k;
create an oblivious key-value store (OKVS) using a set of key-value pairs ({xᵢ, Fₖ(xᵢ)}) for each item xᵢ in an item set X that is private to the first party; and
transmit the OKVS to a third computer system operated by a third party.

16. The first computer system of claim 15 wherein upon receiving the random key k, the second computer system:
creates the pseudorandom function Fₖ using the random key k; and
computes y′ᵢ=Fₖ(yᵢ) for each item yᵢ in an item set Y that is private to the second party.

17. The first computer system of claim 16 wherein upon receiving the OKVS, the third computer system:
decodes the OKVS using each item zᵢ in an item set Z that is private to the third party, resulting in a set of values z′ᵢ.

18. The first computer system of claim 17 wherein the second and third computer systems execute a two-party private set intersection (PSI) protocol using y′ᵢ and z′ᵢ as inputs in order to determine an intersection of the item sets X, Y, and Z.

19. The first computer system of claim 18 wherein the two-party PSI protocol executed by the second and third computer systems is a server-aided two-party PSI protocol.

20. The first computer system of claim 19 wherein the first computer system acts as a server in the server-aided two-party PSI protocol.

21. The first computer system of claim 15 wherein the OKVS is configured to:
output Fₖ(xⱼ) when decoded on an input xⱼ in the item set X; and
output a random value when decoded on an input that is not in the item set X.
